(19) United States
(12) Patent Application Publication
(10) Pub. No.: US 2015/0028209 A1
(43) Pub. Date: Jan. 29, 2015

(54) Refrigerant Gas Leak Detector

(71) Applicants: Rey P. Harju, San Clemente, CA (US); W. Travis Ault, San Clemente, CA (US)

(72) Inventors: Rey P. Harju, San Clemente, CA (US); W. Travis Ault, San Clemente, CA (US)

(21) Appl. No.: 13/952,505

(22) Filed: Jul. 26, 2013

(51) Int. Cl. G01M 3/04

(52) U.S. Cl. CPC G01M 3/047
USPC 250/338.5

(57) ABSTRACT

An infrared leak detector for detecting gas leaks in a pressurized gas source includes a housing that contains a sampling chamber, an infrared emitter for emitting IR energy, a filter that allows IR energy in the range of approximately 7 to approximately 14 microns to pass therethrough, a sensor that detects IR energy that has passed through the single filter to detect the presence of selected gas constituents in the gas sample, and a pump arranged to force a gas sample from a suspected gas leak that emanates from the pressurized gas source though the sampling chamber.

### BACKGROUND OF THE INVENTION

1. Field of the Invention

This invention relates generally to gas leak detection and particularly to detection of gas leaks in heating, ventilating and air conditioning (HVAC) apparatus. More particularly, this invention relates to infrared optical instruments for detection of gas leaks.

2. Description of the Prior Art

U.S. Pat. No. 7,022,993 specifies two infrared (IR) filters. One filter is arranged to pass wavelengths of infrared light that is absorbed by refrigerants (primarily 8-10 microns) and one filter is arranged to block IR energy that is absorbed by water vapor and other gases at wavelengths that are 6 microns and below. U.S. Pat. No. 7,022,993 takes it as fact that these contaminants can cause false triggering. (see Col. 6, line 25 of U.S. Pat. No. 7,022,993). They have caused false triggering in other leak detection technologies.

The current patent requires the whole instrument to be self-contained in one package. This results in a design with a long, unwieldy sample selecting tube fixed to a large, cumbersome body. This two-part innovation is to separate the wand and the body because their functions are entirely different.

### SUMMARY OF THE INVENTION

This invention is an improvement over the infrared (IR) leak detector disclosed in U.S. Pat. No. 7,022,993, the entire disclosure of which is hereby incorporated into the present disclosure. U.S. Pat. No. 7,022,993 discloses an IR instrument for detecting refrigerant gas leaks. The apparatus includes a sampling tube that encloses an IR emitter, a first filter for blocking IR energy having wavelengths of 6 microns and below, a second filter for passing IR energy having wavelengths between 8 and 10 microns and an IR detector. The apparatus of U.S. Pat. No. 7,022,993 is designed to be contained in a single hand-held housing.

It has been discovered that the 6-micron filter mentioned above is not necessary for providing a satisfactory refrigerant gas leak detector. Therefore, a first embodiment of the present invention includes only one filter mounted inside a single hand-held housing. The filter preferably passes IR energy having wavelengths between 7 and 14 microns through the sampling tube to the detector. It has also been discovered that omitting the first filter allows an increase in the intensity of IR energy upon the detector. Not only does omitting the 6-micron filter potentially lower the cost, but it also allows energy that would otherwise be blocked by the 6-micron filter to pass so that it can be absorbed by refrigerants. This includes energy both above and below 6 microns, since even the 6 micron filter blocks some energy in the 8-10 micron bandwidth. Having increased energy incident upon the detector provides increased sensitivity to gas leaks and provides a higher signal to noise ratio in the instrument according to the present invention.

A portable handheld infrared leak detector according to the present invention for detecting gas leaks in a pressurized gas source may comprise a single housing that contains a sampling chamber, an infrared emitter for emitting IR energy, a single filter that allows IR energy in the range of approximately 7 to approximately 14 microns to pass therethrough, a sensor that detects IR energy that has passed through the single filter to detect the presence of selected gas constituents in the gas sample, and a pump arranged to force a gas sample from a suspected gas leak that emanates from the pressurized gas source though the sampling chamber.

Another embodiment of the present invention includes two housings. A first housing preferably encloses a pump and the electronics for processing signals from the IR sensor. The sampling chamber containing the IR source and the IR sensor are in a separate second housing structure that is connected to the first housing by a flexible hose. The two-housing embodiment of the invention may include one or two filters. A tubular wand extends from the sampling chamber and has a sampling tip that may be placed near where a suspected gas leak exists. This alternative embodiment allows the sampling tip to be placed close to suspected leak locations that would be difficult to access with a device that includes all the necessary components in a single housing.

A two-part portable handheld infrared leak detector according to the present invention for detecting gas leaks in a pressurized gas source may comprise a housing, a sampling chamber that encloses an infrared (IR) source, an IR sensor and a single filter that allows IR energy in the range of approximately 7 to approximately 14 microns to pass from the IR source to the IR sensor, a tubular wand extending from a second end of the sampling chamber, the tubular wand having an open end for receiving therein a gas sample to be drawn into the sampling chamber, the IR sensor being responsive to the intensity of IR energy incident thereon to detect the presence of selected gaseous substances in the gas sample.

The two-part portable handheld infrared leak detector according to the present invention may further include a second filter that blocks IR energy having wavelengths of 6 microns and below to prevent these wavelengths from entering the sampling chamber.

### BRIEF DESCRIPTION OF THE DRAWINGS

FIG. 1 schematically illustrates an IR optical gas leak detector according to the present invention;

FIG. 2 is a block diagram of electrical circuitry that may be used for processing electrical signals output from the IR optical gas leak detector of FIG. 1; and

FIG. 3 illustrates a two-part IR optical gas leak detector according to the present invention.

### DETAILED DESCRIPTION OF THE INVENTION

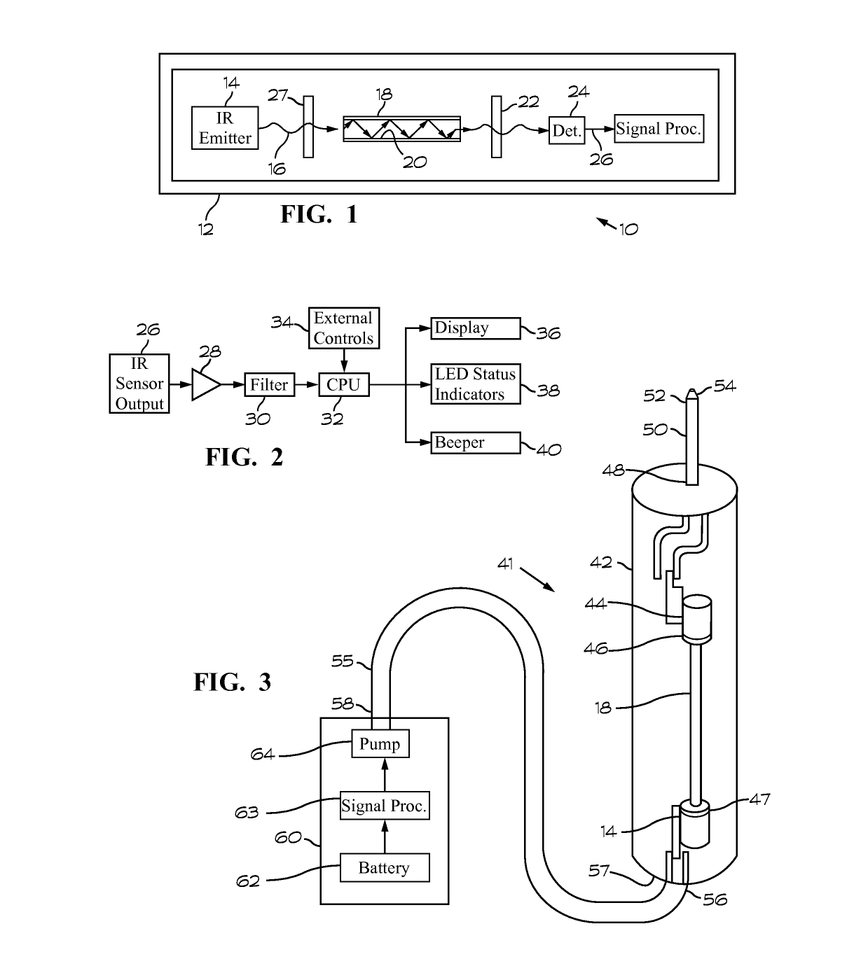

FIG. 1 illustrates the basic features of a first embodiment of a gas leak detector 10 according to the present invention. A housing 12 encloses an IR emitter 14 that emits IR radiation 16, a tube 18 having a highly reflective inner wall 20, a bandpass IR filter 22 and a thermal energy sensor 24.

The IR emitter 14 emits IR radiation 16 that enters the tube 18. A gas sample that is suspected to include leaked refrigerant gas is forced into the tube 18 by a pump as disclosed in U.S. Pat. No. 7,022,993. The suspected contaminants absorb IR energy in the wavelength range of 7 to 14 microns. Therefore, the bandpass IR filter 22 is formed to include silicon, which passes IR wavelengths between 7 to 14 microns and attenuates wavelengths outside the 7 to 14 micron range of interest. The thermal energy sensor 24 produces an electrical signal that indicates the intensity of the IR energy that has passed through the IR bandpass filter 22 to the sensor 24.

The housing 12 may also enclose a window 27 that is preferably made of germanium to keep the gas sample away from the IR emitter.

FIG. 2 illustrates signal processing circuitry that may be included in the present invention. The IR sensor output 26 is input to an amplifier 28. The amplified sensor output is filtered by a filter 30 before being input to a central processing unit (CPU) 32. The CPU 32 receives control signals from an external controls device 34. The CPU 34 is arranged to provide output signals to a display 36, status indicator lights 38 and to a beeper 40 that provides an audible signal when a leak is detected.

FIG. 3 illustrates a two-component embodiment of a gas leak detector 41 according to the present invention. A first housing 42 encloses a the IR emitter 14, the tube 18 and a sensor module 44 that preferably has a 7 to 14 micron bandpass IR filter 46 formed integrally therewith. The IR emitter may include a 6 micron and below IR filter 47. A first end 48 of a gas sampling tube 50 that is preferably formed a hollow tube extends from a first end of the first housing 42. A gas input port 54 is connected to the second 52 end of the gas sampling tube 50.

A flexible hose 55 has a first end 56 connected to the second end 57 of the housing 42. The other end 58 of the hose 55 is connected to a second housing 60. The second housing 60 encloses a battery 62, a signal processing circuit board 63 and a pump 64. When battery power is supplied to the pump 64, a gas sample is drawn into the tube 18 so that the presence of refrigerant gas leaks may be detected in the manner described above.

The function of the sample selection tube 52 is to pass its intake port 54 near a suspected leak. Suspected leaks can be in hard to reach places. This new sample selection tube 5 is innovative in several ways. The sample selection tube 52 is shorter than is found in the prior art. Most of the time while using the gas leak detector 41, the user has his hand on the housing 42, which serves as a handle, with the sample selection tube 52 extending approximately 8″ from the handle. When the user needs to reach further, he just holds the bottom of the handle 42, which extends the working distance to the length of the handle plus the length of the tube 50. The user isn't burdened by having to use the full length of a floppy tube that is fixed to a large unwieldy body every time as is required by the prior art.

The distance the sample travels from tube intake 54 to the sensor 44 is approximately half the distance of current designs, making the reaction time approximately half the time required by the prior art. This is important because IR leak detectors require a sweeping motion and only trigger after they pass the leak. The faster the reaction time, the close the trigger indication is to the leak. It's much easier to locate a leak when the leak detector triggers at 1″ past the leak rather than 2″ past the leak.

The gas leak detector 41 shown in FIG. 3 is lighter in weight than the prior art, making the present invention easier to use than the prior art. All of the heavy components are stored in the second housing 60.

The sample selecting tube 52 is much smaller in diameter than the current floppy tubes that current one-piece designs use. This means it can fit into much tighter spaces.

The sample selection tube 50 is rigid, so it doesn't flop around like current tubes. It's much easier to control, since the floppy tubes currently in use typically don't hold a straight shape when extended straight.

Small attachments to the tip 52 can change the location and direction of the input port much more effectively than the floppy tube currently used. It is very difficult to bend the current floppy tubes around to get to the back of a pipe. With the new wand, we just attach a small curved tube or a molded plastic tube designed to receive the sample from a different direction.

The housing 60 holds the heavy components such as the pump 64 and battery 62. With the two-piece design, the housing (handle) 42 is light and agile. The housing 60, which can be held with the other hand, put in a pocket, or attached to a belt where the heavier weight doesn't interfere with placement of the gas sample input tube 50. The housing 42 and the housing 60 and body are only connected by the hose 55 and wires (not shown) so they can be handled independently.

The emitter 14, which is in the handle 42, is very sensitive to vibration from the pump motor 64. In the two-part design of FIG. 3, the pump 64 is not in the same housing as the emitter 14, so there is no vibration to cause false triggering.

The sensor module 44 is also sensitive to fluctuating sample gas pressures. Since the pump 64 and the sensor module 44 are separated by approximately three feet of flexible hose 55, any pressure fluctuation from the pump 64 is dampened through the hose 55. The flow of sample gas to the sensor module 44 is smoother than when the pump is in the same housing as the sensor as is done in the prior art.

What is claimed is:

1. An infrared leak detector for detecting gas leaks in a pressurized gas source, comprising:
a housing that contains:
a sampling chamber;
an infrared emitter for emitting IR energy;
a single filter that allows IR energy in the range of approximately 7 to approximately 14 microns to pass therethrough;
a sensor that detects IR energy that has passed through the single filter detect the presence of selected gas constituents in the gas sample; and
a pump arranged to force a gas sample from a suspected gas leak that emanates from the pressurized gas source though the sampling chamber.

2. The infrared leak detector of claim 1 arranged to detect gas leaks that include the gas leak refrigerants selected from at least one of (HFC) Hydrogenated Fluorocarbon compounds (HCFC) Hydrogenated Chorofluoro Fluorocarbon compounds, (CFC) Choroflouro Carbon compounds.

3. A two-part portable handheld infrared leak detector for detecting gas leaks in a pressurized gas source, comprising:
a housing;
a sampling chamber that encloses an infrared (IR) source, an IR sensor and a single filter that allows IR energy in the range of approximately 7 to approximately 14 microns to pass from the IR source to the IR sensor;
a tubular wand extending from a second end of the sampling chamber, the tubular wand having an open end for receiving therein a gas sample to be drawn into the sampling chamber, the IR sensor being responsive to the intensity of IR energy incident thereon to detect the presence of selected gaseous substances in the gas sample.

4. The infrared leak detector of claim 3 arranged to detect gas leaks that include the gas leak refrigerants selected from at least one of (HFC) Hydrogenated Fluorocarbon compounds (HCFC) Hydrogenated Chorofluoro Fluorocarbon compounds, (CFC) Choroflouro Carbon compounds.

5. A two-part portable handheld infrared leak detector for detecting gas leaks in a pressurized gas source, comprising:
a housing;
a sampling chamber that encloses an infrared (IR) source, an IR sensor and a filter that allows IR energy in the range of approximately 7 to approximately 14 microns to pass from the IR source to the IR sensor;
a tubular wand extending from a second end of the sampling chamber, the tubular wand having an open end for receiving therein a gas sample to be drawn into the sampling chamber, the IR sensor being responsive to the intensity of IR energy incident thereon to detect the presence of selected gaseous substances in the gas sample.

6. The infrared leak detector of claim 5 further comprising an IR filter arranged to prevent IR energy having wavelengths of 6 microns and below from interacting with the gas sample.

7. The infrared leak detector of claim 5 arranged to detect gas leaks that include the gas leak refrigerants selected from at least one of (HFC) Hydrogenated Fluorocarbon compounds (HCFC) Hydrogenated Chorofluoro Fluorocarbon compounds, (CFC) Choroflouro Carbon compounds.
